(19) United States
(12) Patent Application Publication
(10) Pub. No.: US 2001/0054442 A1
(43) Pub. Date: Dec. 27, 2001

(54) Releasable non-return valve with connector

(76) Inventor: Wolfgang Voss, Schwerte (DE)

Correspondence Address: James C. Wray, Suite 300, 1493 Chain Bridge Road, McLean, VA, 22101, US

(21) Appl. No.: 09/853,630

(22) Filed: May 14, 2001

(30) Foreign Application Priority Data
May 12, 2000 (DE) 100 23 398.8
Aug. 23, 2000 (DE) 100 41 324.2

(51) Int. Cl. F16K 31/122

(52) U.S. Cl. 137/522; 251/63.4

(57) ABSTRACT

An especially for the subterranean mining industry intended non-return valve which is very safe and has a long life-cycle contains a valve piston 10 which is set in a case 18 against the pressure of the valve spring 12 which can be manipulated via the control piston 6. The case 18 contains an inner chamber 19 which is connected to the water release opening and the drilling of the casing via a connecting drilling 25. Thus, a hydraulic damping can be achieved which together with the shape of the valve piston 10 as a plastic piston guarantee for a long life-cycle.

The invention concerns a non-return valve, especially for hydraulic extension used in subterranean mining of hard coal, which features a casing with multiple connectors containing a control piston and a valve piston in an axial position to the control piston which both can be moved, while the control piston can, when put under according pressure, push the valve piston out of the sealing against the pressure of a valve spring.

So called releasable non-return valves are very commonly used in the industry, whereas their main function is to avoid the backflow of the hydraulic fluid out of a filled chamber. A control piston can push the corresponding valve piston out of its sealing if for example the hydraulic fluid in a hydraulic prop is to be released or is to be pumped out. For this, the control piston is being pressured with the hydraulic fluid so that it pushes the valve piston out of its sealing against the pressure of a valve spring. It is common knowledge to improve the sealing by giving the valve piston a plastic top which is fitted at the sealing of the valve or better the casing. Such plastic tops are usually fitted with an o-ring sealing and screwed onto the brass or metal valve piston in order to prevent the hydraulic fluid from leaking or entering the area behind the sealing. Due to the frequent change of pressure, these non-return valves often leak because the plastic top comes loose and can no longer guarantee the necessary sealing. The corresponding plastic has an advantageous sealing effect in the area of the sealing and also adds a damping effect, but it cannot avoid the previously described disadvantages, thus the valve has to be replaced frequently which represents a considerable strain and at the end even endangerment especially in the subterranean mining industry.

The invention therefore has the task to create a releasable and also damping non-return valve with a long life-cycle.

The task is solved according to the invention by positioning the valve piston in a case fitted in the drill-hole in the casing against the pressure of the valve spring so that its position can be adjusted, whereas the case contains a water filling and is shaped to regulate the connection of the inner chamber with the drill-hole in the casing.

According to the invention, the case is fitted in the drill-hole in the casing and is filled with water so that a fast pressured movement of the control piston not only has to affect the valve spring but also has to push the water in the case through the “non-sealing parts” into the drill-hole of the casing. Thus, the “non-sealing parts” act as a throttle so that it can have a specific damping effect. This version ensures that even with long life-cycles a hydraulic dampened non-return valve has been created which can be released via the hydraulic fluid as customary. The return spring is then responsible to replenish the water filing in the case because it sucks the necessary water into the created chamber of the drill-hole in the casing.

After an appropriate further development of the invention it is that the chamber of the case is sealed towards the outer wall of the piston but features a narrow opening between the outer wall of the case and the inner wall of the drilling in the casing to release the water as well as a regulating connecting drill-hole in the bottom. Here, the connecting drill-hole functions as a throttle while the remaining opening adds to the effect. Due to its size the connecting drill-hole regulates the flow of the water when the valve piston is pushed out of its sealing position so that as previously stated an exact damping effect is ensured.

Another way to create a damping effect is for the chamber in the case to have a closed bottom but therefore to have an opening between the outer wall of the piston and the inner wall of the case in order to release the water. With this version, the water in the chamber between the case and the valve piston is pushed through the opening into the drill-hole of the casing so that the lifting motion of the valve piston out of the sealing position can be soft and slow. Reversibly, the water will be sucked back into the chamber through the opening when the valve spring pushes the valve piston back into its sealing position. Any vibration of the valve is therefore prevented.

It is also possible that the water release opening between the outer wall of the piston and the inner wall of the case and/or the other water release opening and the connecting drill-hole are intended. This means that all three “throttles” can be used if this is found to be appropriate for corresponding reasons.

The referenced invention is being optimized by making the casing and the case of brass or steel and to make the valve piston from a corresponding material. This is to ensure a fast and efficient sealing effect especially in the area of the sealing. It is also possible that the valve piston just features a special coating which corresponds with the material of the casing and the case.

It was found to be especially functional to use a plastic piston as a valve piston especially a hard synthetic material. This combination of brass/steel or hard plastic ensures an optimal seal in the area of the sealing without the danger that the sealing surface of the valve piston would come loose from the piston. This danger exists if the piston is only coated with a plastic surface. For this reason it should consist of plastic in its entirety. Other coatings are possible, but then not made of plastic.

According to another functional design of the invention it is intended that the valve piston features a sack drilling which partially encloses the valve spring. This sack drilling first of all holds the valve spring securely and makes sure that it cannot be deformed due to too much pressure. In addition, the remaining bottom of the valve piston forms a type of block safety-catch for the spring since it prevents the valve piston to enter too far into the case.

Another functional design calls for a cone-shaped top of the sealing surface of the valve piston at the sealing and a cone shaped drilling of the valve piston and the pestle connecting the valve piston and the control piston. With this, the valve piston is doubly secured in its path, once by the case and also in the area of the tip through the pestle so that there cannot be any irregular movements of the valve piston during the initial contact with the valve or during the opening of the non-return valve.

To ensure an exact fit of the tip of the valve piston in the pestle, it is intended that the cone-shaped drilling in the pestle leads into a short sack drilling so that there is sufficient friction between the pestle and the tip of the valve piston and thus it is prevented that it slides out or comes out by accident. The short sack drilling also serves in the way that it prevents a movement during the insertion of the valve piston into the cone-shaped drilling because a film cannot build in the contact area or in the surface area because the water that might be there will automatically be pushed into the short sack drilling.

The sufficient stability of the pestle in the connecting area between the valve piston and the pestle is ensured because the pestle is shaped to extend like a trumpet in the area of the cone shaped drilling. Thus there is an exact connection between the pestle and the tip of the valve piston.

Previously it has been stated that the chamber of the case is also sealed towards the valve piston. According to the invention this is a result of the fact that the outer wall of the piston and/or the inner wall of the case features a ring nut containing an O-ring. This ring nut and the O-ring take care of a corresponding sealing effect also when the valve piston is pushed into the case as intended. The o-ring always ensures an effective sealing.

To ensure a lasting sealing, also when the valve piston is pushed relatively far out of the case, the invention intends that the ring nut is positioned towards the bottom of the piston with a sack drilling in the valve piston. In addition, the distance to the “bottom” of the valve piston is limited to 1 to 3 mm. Such distances customarily are around or more than 5 mm where as the tighter distance ensures the previously described advantages together with the necessary safety.

The desired hydraulic damping is reached by filling the chamber of the case with water which can only be pushed out through the connecting drilling in the bottom of the case or reversibly can be sucked back in. To facilitate the set up it is intended that the case drilling features an inner thread towards the case to connect with a manometer or a stopper. This stopper or manometer connection ensures a sealing effect in this area so that the efficiency of the hydraulic damp can be ensured, thus a leaking of the valve can surely be avoided.

The exchange of the water filling of the chamber of the case to the drill-hole of the casing which is still necessary is ensured because the drilled connection in the case measures a diameter of 0.6 to 1.5 mm, preferably 1.2 mm. At the same time, the bottom of the case features a connecting channel which enables or optimizes an outflow or inflow of water towards the chamber of the valve piston. Tests have shown that the described diameter of the connecting drill-hole is optimized at 1.2 mm to ensure a damping effect while avoiding to become a hindrance. The corresponding connecting drill-hole, the connecting channel and the opening to release the water that remained in the casing ensure the specified exchange of the water filling.

To ensure a sufficient, or better a large enough opening for the release of the water, the invention suggests that the outer wall of the case and the inner wall of the drill-hole in the casing are designed corresponding to each other and are preferably untreated to allow room to release the water. Surprisingly, this results in an opening of about 22 mm around the case so that the necessary water exchange is ensured.

The invention is distinguished due to the fact that a non-return valve has been designed that ensures a long life-cycle because the valve piston is formed as such that in the area of the sealing a complete sealing effect is accomplished without creating damage to the valve piston. The valve piston itself is damped so that not only the valve spring but also the corresponding water filling take care of an even gliding thus opening and closing of the valve piston. The valve piston itself is for once set in the case as well as in the pestle and therefore in the control piston so that an even movement of the valve piston can be achieved which contributes to the long life-cycle of such valves. Advantageous is also the fact that the non-sealing characteristic or the controlled non-sealing characteristic of a throttle can be intended between the valve piston and the case as well as the case and the drill-hole of the casing or in other areas.

Additional details and advantages of the invented object can be found in the following description of the corresponding drawings where a preferred design example is depicted with the necessary details and individual parts.

It is shown in:

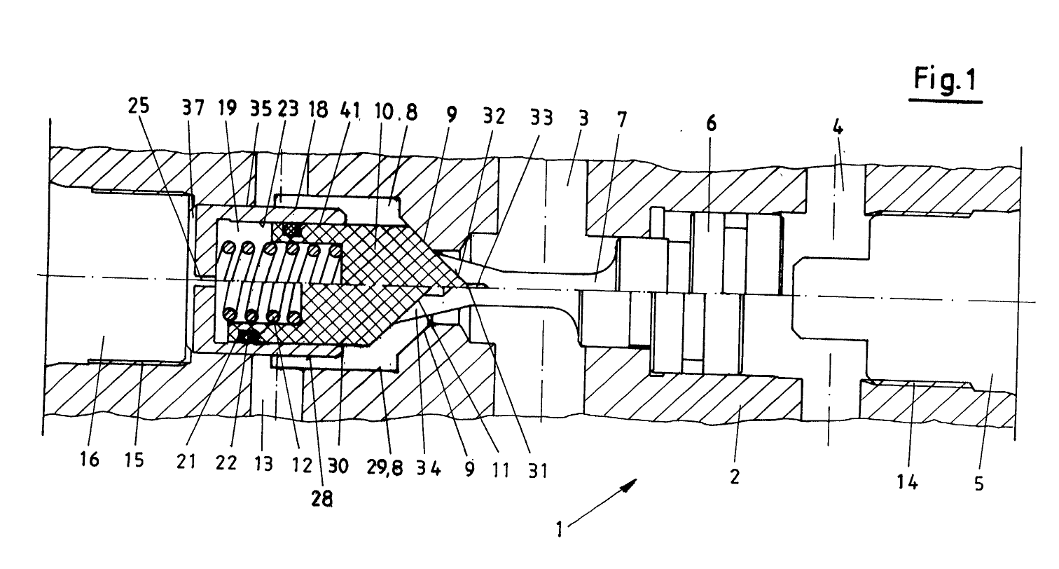

FIG. 1 a simplified section of a non-return valve

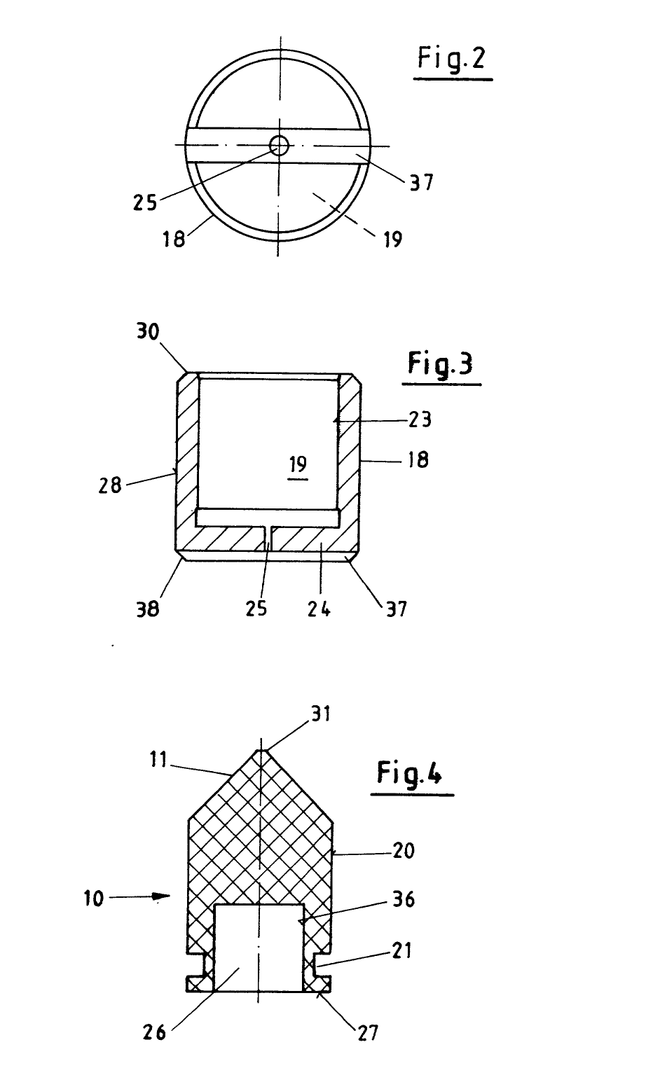

FIG. 2 a case viewed from the bottom

FIG. 3 a longitudinal section of a case and

FIG. 4 a longitudinal section of a valve piston.

FIG. 1 shows a simplified version of a non-return valve 1 where the casing is only slightly indicated. The casing 2 features a number of connections 3, 4 as well as the control pressure connector 5 through which the necessary hydraulic fluid or other initiation fluids are lead to the control piston 6.

This control piston 6 is connected with the valve piston 10 via a pestle 7 so that both can evenly be moved in the drill-hole 8 of the casing 2 in axial direction. Thus the valve piston 10 with its sealing surface 11 is pushed out of its sealing 9 by the control piston 6 and the pestle 7 so that the hydraulic fluid can enter into the area of the connection 13. With this movement, which is depicted in the lower part of the drawing according to FIG. 1, the valve spring is put under pressure so that due to its own tension to return to its original position it pushes the control piston 6 via the pestle 7 back into the position as depicted in the upper part of FIG. 1 after the pressure lessens or better after the control piston connection is closed.

In FIG. 1 you can see that the control pressure connection 5 features a thread 14 so that the corresponding part can easily be inserted. A similar connection with an inner thread 15 is also intended at the opposite end of the drill-hole of the casing 8. Here, a stopper 16 is depicted in FIG. 1 with which the drill-hole of the casing 8 can be closed on this side. With the removal of the stopper 16 the case 18 and also the valve piston 10 can be removed or in reverse order can be put in place.

The case 18 which takes in the valve piston 10 features a deep enough chamber 19 in which the valve piston can be set and moved. The outer wall of the piston 20 features a ring nut 21 which again features an o-ring 22. This o-ring 22 grinds at the inner wall of the case 23 and ensures that the chamber 19 of the case 18 is sealed on this side against the drill-hole of the casing 8.

In the bottom 24 of the case 18 a connecting drill-hole 25 is placed which ensures that the chamber 19 of the case 18 is supplied with water via the connecting channel 37 and the opening 35 to release the water between the inner wall 29 of the drill-hole 8 in the casing and the wall of the case 28.

The valve spring 12 is set in the chamber 19 of the case 18 in such a way that it can safely rest on the bottom and on the other side against the valve piston 10. For this, the valve piston 10 features a sack drilling 26 which is however shaped in a way that the ring nut 21 with the o-ring can securely be placed. This ring nut 21 is positioned in close proximity to the piston bottom 27 to avoid an extension over the rim of the case 30.

The piston is set as previously described inside the case which consists of brass or a similar material so that the piston can be moved while it rests on the opposite side of the tip of the piston 31 in a cone-shaped drilling 32 of the pestle 7 and therefore can be guided. The necessary secure fit of the sealing surface 11 on the sealing 9 of the drill-hole of the casing 8 is facilitated by forming a short sack drilling 33 in the area of the outer tip 31 which is flattened as shown in FIG. 4.

For the intake of the tip of the piston 31 the pestle 7 features an extension 34 which is formed like a trumpet to ensure the necessary strength of the wall.

FIG. 1 clarifies that the special and described form of the non-return valve ensures an optimal life-cycle.

FIG. 2 shows a case 1 from the bottom 24 where you can see the connecting drill-hole 25. The connecting drill-hole 25 ends in the connecting channel 37 which is also seen in FIG. 3. The connecting channel 37 runs diagonal through the bottom 24 of the case 18 so that it is ensured that the water can get into the area of the water release opening 35 via the connecting drilling 25. The bevel 38 not only facilitates the insertion of the case 18 but also eases the ‘water flow’. No. 36 denotes the inner wall of the case 18; No. 19 the entire inner chamber.

FIG. 4 shows another section of the valve piston 10 which first of all indicates that the tip of the piston 31 is flattened while the sealing surfaces 11 which are a result of the special form of the tip of the piston 31 are securely laying on the sealing position 9 of the drilling of the casing 8.

The close proximity of the ring nut 21 to the bottom of the piston 27 can be clearly seen on FIG. 4.

Previously it was explained that the specific leakage between the inner chamber 19 of the case 18 and the drilling in the casing is reached through the water flow opening 35 while in the bottom 24 of the case 18 a regulating connection drilling is intended. In FIG. 1 there is a second water flow opening which is designated with the sign 41, because also here, then without the o-rings 22, a water flow opening 41 is intended between the inner wall of the case 23 and the outer wall of the piston 20.

All specified characteristics, as well as those which can be seen on the drawings are regarded by themselves as well as in combination essential to the invention.

1. Non-return valve, especially for hydraulic extension used in subterranean mining of hard coal, which features a casing (2) with multiple connectors (3, 4, 5) containing a control piston (6) and a valve piston (10) in an axial position to the control piston which both can be moved, while the control piston (6) can, when put under according pressure, push the valve piston (10) out of the sealing (9) against the pressure of a valve spring (12),
characterized by the fact
that the valve piston (10) is positioned in a case fitted in the drill-hole (8) in the case (18) against the pressure of the valve spring (18) so that its position can be adjusted whereas the case (18) contains a water filling and is shaped to regulate the connection of the inner chamber (19) with the drill-hole (8) in the casing.

2. Non-return valve according to claim 1,
characterized by the fact
that the chamber (19) of the case (18) is sealed towards the outer wall (20) of the piston but features a narrow opening (35) between the outer wall of the case (28) and the inner wall (29) of the drilling (8) in the casing to release the water as well as a regulating connecting drill-hole (25) in the bottom (24).

3. Non-return valve according to claim 1,
characterized by the fact
that the chamber (19) in the case (18) has a closed bottom (24) but therefore an opening (41) between the outer wall of the piston (20) and the inner wall of the case (23) in order to release the water.

4. Non-return valve according to claim 3,
characterized by the fact
that the water release opening (41) between the outer wall of the piston (20) and the inner wall of the case (23) and/or the other water release opening (35) and the connecting drill-hole (25) are intended.

5. Non-return valve according to one of the previous claims,
characterized by the fact
that the casing (2) and the case (18) of brass or steel and to make the valve piston (10) from a corresponding material.

6. Non-return valve according to one of the previous claims,
characterized by the fact
that the valve piston (10) is made out of plastic.

7. Non-return valve according to claim 1,
characterized by the fact
that the valve piston (10) features a sack drilling (26) which partially encloses the valve spring (12).

8. Non-return valve according to one of the previous claims,
characterized by the fact
that a cone-shaped top of the sealing surface (11) of the valve piston (10) at the sealing (9) and a cone shaped drilling (32) of the valve piston (10) and the pestle (7) connecting the valve piston (10) and the control piston (6).

9. Non-return valve according to one of the previous claims,
characterized by the fact
that the cone-shaped drilling (32) in the pestle (7) leads into a short sack drilling (33).

10. Non-return valve according to one of the previous claims,
characterized by the fact
that the pestle (7) is shaped to extend like a trumpet in the area of the cone shaped drilling (32).

11. Non-return valve according to one of the previous claims,
characterized by the fact
that the outer wall(20) of the piston and/or the inner wall (23) of the case features a ring nut (21) containing an O-ring (22).

12. Non-return valve according to one of the previous claims,
characterized by the fact
intends that the ring nut (21) is positioned towards the bottom (27) of the piston with a sack drilling (26) in the valve piston (10).

13. Non-return valve according to one of the previous claims,
characterized by the fact
that the case drilling (8) features an inner thread (15) towards the case to connect with a manometer or a stopper (16).

14. Non-return valve according to one of the previous claims,
characterized by the fact
that the drilled connection (8) in the case (18) measures a diameter of 0.6 to 1.5 mm, preferably 1.2 mm.

15. Non-return valve according to one of the previous claims,
characterized by the fact
that the outer wall (28) of the case and the inner wall (29) of the drill-hole (8) in the casing are designed corresponding to each other and are preferably untreated to allow room to release the water (35).
